(19) United States
(12) Patent Application Publication
(10) Pub. No.: US 2026/0339493 A1
(43) Pub. Date: Oct. 29, 2026

(54) Image-Based Content Navigation

(71) Applicant: GloryMakeup Inc., Taipei City (TW)

(72) Inventor: Daniel Ariel Donohue, Miami, FL (US)

(21) Appl. No.: 19/189,223

(22) Filed: Apr. 24, 2025

(51) Int. Cl. G06F 3/04845; G06F 3/0482; G06F 3/0485; G06F 3/0488

(52) U.S. Cl. CPC G06F 3/04845; G06F 3/0482; G06F 3/0485; G06F 3/0488

(57) ABSTRACT

An image-based content navigation method enables transitions of viewing modes via user gestures. In response to a first sequence of un-pinch gestures on a display from a user, content windows on the display transition to progressively larger window sizes in progressively larger viewing modes. Each content window in multiple viewing modes contains at least an image and a scrollable list of user interface (UI) elements. Different viewing modes have different layouts on the display. An extended content page is displayed in response to the user selecting a UI element in a current viewing mode of a current window size. Upon the user exiting the extended content page, the display returns to the current viewing mode of the current window size. In response to a second sequence of pinch gestures on the display, the content windows on the display transition to progressively smaller window sizes in progressively smaller viewing modes.

### TECHNICAL FIELD

Embodiments of the invention relate to navigation of image-based online contents on a touch-sensing display of a computing device.

### BACKGROUND OF THE INVENTION

Portable devices such as smartphones typically have small screens that limit the amount of information displayable at a time. A small screen size also limits the number of images displayable at a time. A user typically has to perform multiple different types of gestures on a touch screen to find an image of interest and to view the image and the related information at a desired scale factor. This is especially cumbersome for a social media application where a large number of image-based posts are shared online. For example, a user may scroll the displayed content to find a post of interest, click into the post to view the detailed information, and then click a back arrow somewhere on the screen to return to the display content to continue scrolling. For social media participants to enjoy a smooth and intuitive content navigation experience, a more efficient and user-friendly mechanism is needed. Websites that post a large number of image-based contents can also benefit from an improved content navigation mechanism to enhance the user experience.

### SUMMARY OF THE INVENTION

In one embodiment, a method is provided for image-based content navigation. The method includes the steps of receiving a first sequence of un-pinch gestures on a display from a user, and transitioning content windows on the display to progressively larger window sizes in progressively larger viewing modes in response to the first sequence of un-pinch gestures. Each content window in multiple ones of the viewing modes contains at least an image and a scrollable list of user interface (UI) elements, and different viewing modes have different layouts on the display. The method further includes the steps of displaying an extended content page on the display in response to the user selecting one of the UI elements in a current viewing mode of a current window size, and returning to the current viewing mode of the current window size upon the user exiting the extended content page. The method further includes the steps of receiving a second sequence of pinch gestures on the display, and transitioning the content windows on the display to progressively smaller window sizes in progressively smaller viewing modes in response to the second sequence of pinch gestures.

In another embodiment, a device is provided to perform image-based content navigation. The device includes processing hardware, which further includes one or more processors. The device further includes memory to store a client application with which a user interacts using gestures. The one or more processors are operative to perform the aforementioned image-based content navigation method.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to "an" or "one" embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates an example of content navigation on a display according to one embodiment.

FIG. 2 illustrates an example of a small view according to one embodiment.

FIGS. 3A and 3B illustrate an example of scrolling down and scrolling up, respectively, in the small view according to one embodiment.

FIG. 4 illustrates an example of a medium view according to one embodiment.

FIGS. 5A and 5B illustrate an example of scrolling down and scrolling up, respectively, in the medium view according to one embodiment.

FIG. 6 illustrates an example of a standard view according to one embodiment.

FIGS. 7A and 7B illustrate an example of scrolling down and scrolling up, respectively, in the standard view according to one embodiment.

FIG. 8 illustrates an example of a large view and an expanded large view according to one embodiment.

FIG. 9 is a block diagram illustrating user devices connected to a server according to one embodiment.

FIG. 10 is a block diagram illustrating the device of FIG. 9 according to one embodiment.

FIG. 11 is a flow diagram illustrating a method for image-based content navigation according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The disclosed system and method provide a content navigation mechanism that responds to a user’s touch gestures to resize and rearrange content windows on a display screen. The display screen may display the content of an application, such as a social media application. A main navigation flow of the content navigation can be invoked by a user’s pinch and un-pinch gestures, which cause the viewing modes to transition from one to another. After selecting a viewing mode, a user may leave the main navigation flow by clicking on an UI element, which leads to an extended content page displaying a post, a product, and/or the like. When returning to the main navigation flow, the previously-selected viewing mode of content navigation remains. A user may access the content by downloading the application to a user device, or from a website via a web browser installed on the user device. In one embodiment, the social media application enables participants to publish and share image-based posts. The term “image” as used in this disclosure is defined to encompass photo(s), video(s), 3D content, interactive content, sequenced interactive image(s), animation, computer-generated graphics, and/or any visual media content. In addition to the image(s), an image-based post may also include text, links, icons, graphical objects, widgets, interactive buttons, and UI elements, etc. When multiple image-based posts are displayed on a screen, each post occupies a corresponding content window for displaying the post content on the screen. In the description hereinafter, the term “post” is used to mean an “image-based post.” According to embodiments to be described herein, the content window can be resized in response to the user’s touch gestures, and the locations of the content windows are rearranged depending on the content window size. Furthermore, the content in a content window can be rearranged or hidden depending on the content window size. A user may select a viewing mode by adjusting the size of the content windows (e.g., by applying pinch and un-pinching gestures on a display). A change in the viewing mode not only resizes the content windows but also changes the layout of the content windows on the display. The term “layout” herein is defined as the arrangement of the content window locations on the display. The relative locations of two content windows may change when the layout changes. For example, a multi-column matrix layout in a small view may change to a dual-column layout in a medium view. Thus, two content windows may be displayed side by side in the same row in the small view, but may be displayed in two different rows in the medium view or one on top of the other in the standard view. As will be described in more detail below, a “quick browsing” feature is provided in some of the viewing modes. For example, a user in a viewing mode can click on a “quick browsing” UI element (e.g., a button) in a content window of a post to go to a page of an extended content containing detailed information about an aspect of the post. When the user returns to the post, the viewing mode and the content window size remain as previously selected.

The content navigation mechanism described herein can adapt to a wide variety of applications. In a non-limiting example, a social media application may focus on health and beauty, and participants can share posts such as makeup looks, reviews of cosmetics and makeup accessories, and tutorials of using cosmetics and makeup accessories to create desired makeup looks. The participants may comment on one another’s posts. The cosmetics may include a wide range of health and beauty products that can be applied to a user’s skin. It is understood that other types of applications may also use the content navigation mechanism described herein for users to navigate the image-based contents.

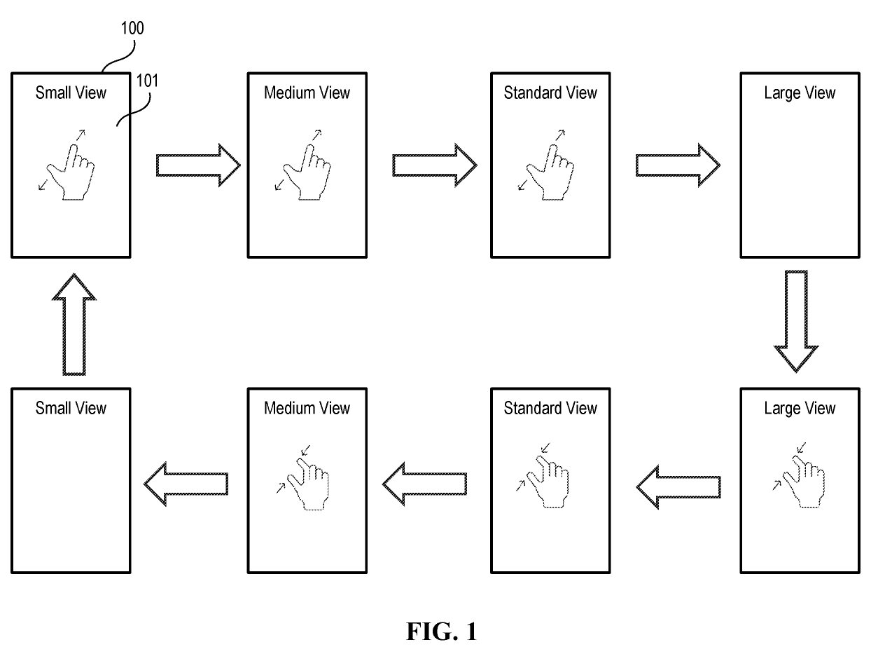

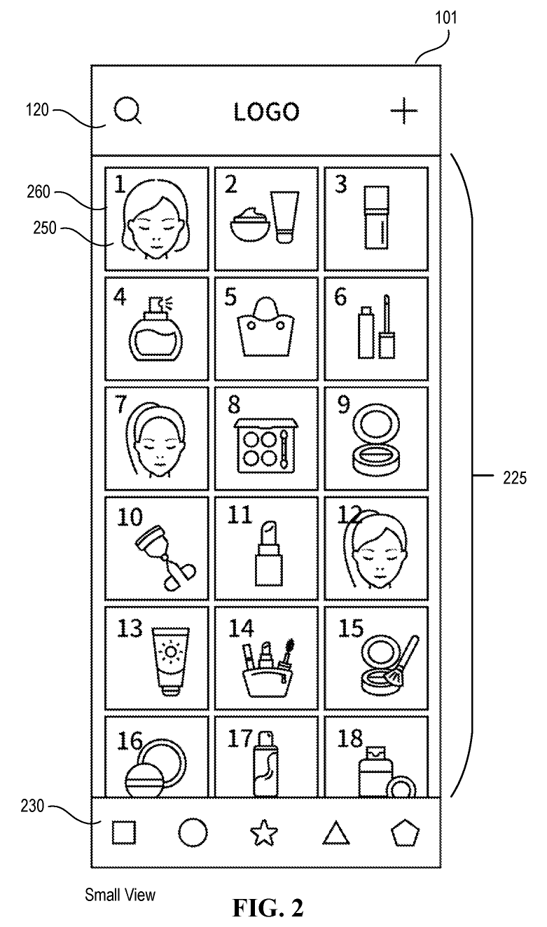

FIG. 1 illustrates an example of content navigation on a display 101 of a device 100 according to one embodiment. An example of the display 101 is a touch-sensing display screen, which includes embedded touch sensors to detect a user’s touch gestures. Another example of the display 101 is a display window (e.g., a browser window) on a touch-sensing display screen, on which multiple display windows may be opened. Non-limiting examples of the touch gestures include swiping, tapping, pinching, un-pinching (a.k.a. spreading), dragging, etc. In one embodiment, the device 100 has a user application (also referred to as a client application or an app) installed thereon. The app provides a user with multiple viewing modes for viewing the app contents on the display 101. A user can navigate from one viewing mode to another by a pinch gesture or an un-pinch gesture. For example, the viewing modes may include a small view, a medium view, a standard view, and a large view, in the order of progressively larger content window sizes for the posts. A user performs an un-pinch gesture by placing two fingers on the display 101 and then moving the fingers apart. As shown in the top row of FIG. 1, a user may use a sequence of un-pinch gestures to scale up the view in multiple steps (e.g., from the small view, to the medium view, to the standard view, and then to the large view). As shown in the bottom row of FIG. 1, a user may use a sequence of pinch gestures to scale down the view in multiple steps (e.g., from the large view, to the standard view, to the medium view, and then to the small view). A user performs a pinch gesture by placing two fingers on the display 101 and then moving the fingers together. A user may also switch back and forth between any two adjacent viewing modes (e.g., between the small and medium views, between the standard and the large views, etc.) by alternating pinch and un-pinch gestures. As will be explained below, the “small”, “medium”, “standard”, and “large” refers to the size of the content window(s) in each view. The term “intermediate views” are used to include both the medium view and the standard view, as these views are between the small view and the large view. In an alternative embodiment, the intermediate views may include additional views having progressively larger content window sizes between the small view and the medium view. According to the embodiments to be described below, the content navigation flow can be directed by a user’s pinch and un-pinch gestures to transition between views of different scale factors in an intuitive manner. FIGS. 2, 4, 6, and 8 show that different viewing modes have different layouts on the display. The figures also show that content windows on the display can transition to progressively larger window sizes in progressively larger viewing modes in response to un-pinch gestures, and the content windows can transition to progressively smaller window sizes in progressively smaller viewing modes in response to pinch gestures. When resizing a content window, text, interactive UI elements, buttons, and features within the content window may be hidden in a particular viewing mode due to size constraints, and may be shown when there is space to display them in the content window. The following description provides further details on the viewing modes.

The touch sensors embedded in the display screen detect many types of hand gestures. When the touch sensors detect a quick pressing-and-releasing gesture of a finger in a single location, the gesture is interpreted as a single “click” or “tap” action. When the touch sensors detect two fingers pressing simultaneously and moving together or apart, the gesture is interpreted as a “pinch” or “un-pinch” action, and other gestures are temporarily deactivated. This allows the pinch (or un-pinch) to zoom action to happen anywhere on the display including in the location where there is a trigger to click. After the pinch or un-pinch, a user can use a click gesture to change the display (e.g., click on an icon and go to a corresponding page). When the touch sensors detect a single press and continuous moving gesture, the command for scrolling up and down (or left and right) is activated, temporarily deactivating all other gestures such as the click, pinch, and un-pinch gestures.

FIG. 2 illustrates an example of the small view according to one embodiment. In the small view, a user can view multiple content windows 260 of multiple posts on the display 101 in a multi-column matrix layout of multiple rows and multiple columns. The matrix layout in the example of FIG. 2 includes three columns. In alternative embodiments, the small view may display the content windows 260 in any number of columns more than two. In one embodiment, each content window 260 in the small view displays a thumbnail 250, which is a reduced-sized version of a photo or a video frame in an online post. The thumbnails 250 in the small view may have the same size. Each thumbnail 250 is clickable. That is, a user can click on a displayed thumbnail 250 to view the corresponding post. Additionally, a user can view the corresponding post by one or more un-pinch gestures without clicking on the thumbnail 250.

The display 101 in the small view also displays a header 220, a footer 230, and a content viewing area 225 between the header 220 and the footer 230. The header 220 may display device-related information (e.g., battery level, network signal strength, etc.), app-related information (e.g. a logo of the app being viewed), user-related information, a search icon, a pull-down menu, etc. The footer 230 may display icons that can be clicked or tapped to show additional user-related information and app-related information, etc. It is understood that in alternative embodiments, some of the items in the header 220 may be shown in the footer 230, and vice versa. In some embodiments, the header 220 and the footer 230 may be displayed on the right and left sides of the display 101. Alternatively or additionally, some of the items in the header 220 and the footer 230 may be displayed on the right and left sides of the display 101. The content viewing area 225 in the small view displays the thumbnails 250 only. The small view allows the user to browse a large number of thumbnails 250 on the display 101 at once.

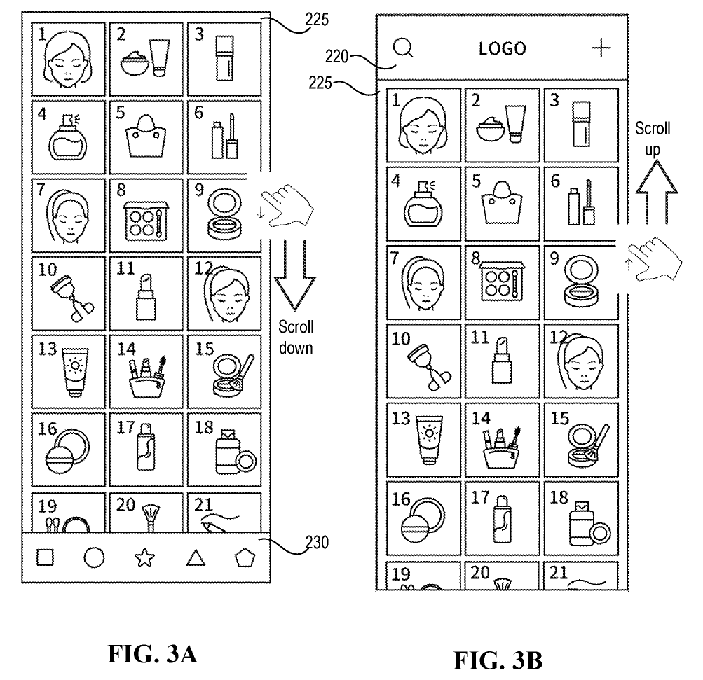

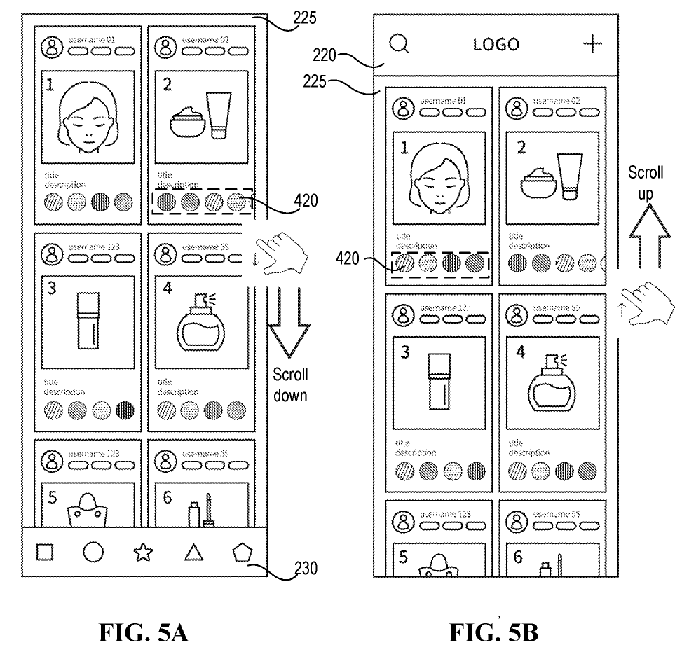

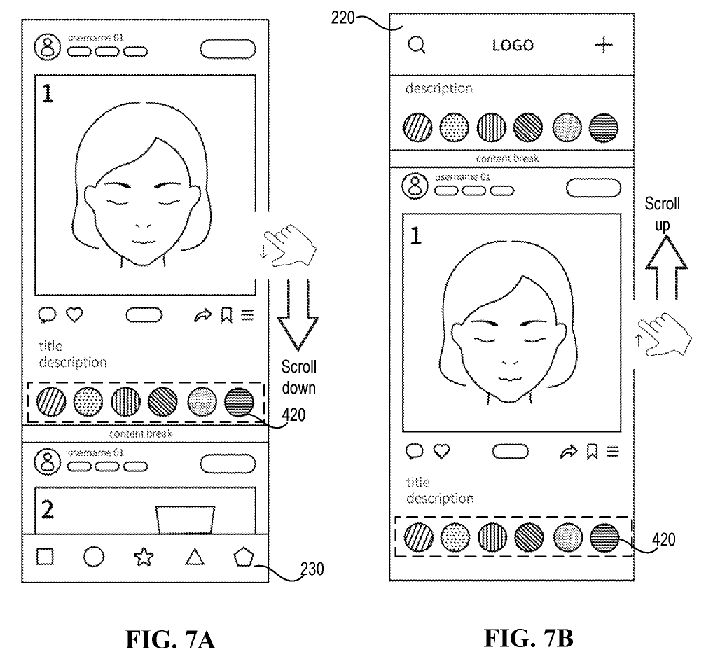

FIG. 3A illustrates an example of scrolling down in the small view according to one embodiment. When a user performs a “down gesture” (e.g., scroll down or swipe down) on the content viewing area 225, the header 220 disappears (i.e., is removed) from the display 101. As the user’s “down gesture” indicates that the user wants to see more content that comes in from the top of the display 101, the removal of the header 220 provides more space to display more content at the top. FIG. 3B illustrates an example of scrolling up in the small view according to one embodiment. When a user performs an “up gesture” (e.g., scroll up or swipe up) on the content viewing area 225, the footer 230 disappears (i.e., is removed) from the display 101. As the user’s “up gesture” indicates that the user wants to see more content that comes in from the bottom of the display 101, the removal of the footer 230 provides more space to display more content at the bottom. When the user scrolls down (FIG. 3A) and then scrolls up (FIG. 3B), the previously-hidden header 220 is restored on the display 101. Conversely, when the user scrolls up (FIG. 3B) and then scrolls down (FIG. 3A), the previously-hidden footer 230 is restored on the display 101. In an alternative embodiment where the header 220 and the footer 230 are shown at the left side and the right side of the display 101, respectively, the “up gesture” and the “down gesture” may be replaced by a “left gesture” and a “right gesture”, respectively, in any of the viewing modes described herein. Thus, the header 220 and the footer 230 may also be referred to as “end sections”, as they can be located at any two opposite ends of the display 101. As will also be shown in FIGS. 5A, 5B, 7D, and 7B, when the display 101 receives a scroll gesture toward a first end of the display 101, one of the end sections (e.g., the header 220 or the footer 230) that is opposite to the first end may be removed from the display 101 in response to the scroll gesture.

A user may scale up a region of the content viewing area 225 by an un-pinch gesture centered at the region. When the user performs an un-pinch gesture on the content viewing area 225 in the small view, the viewing mode changes from the small view to the medium view. When the user performs a pinch gesture on the content viewing area 225 in the medium view, the viewing mode changes from the medium view to the small view. In one embodiment, the pinch and the un-pinch gestures can be performed anywhere on the display 101.

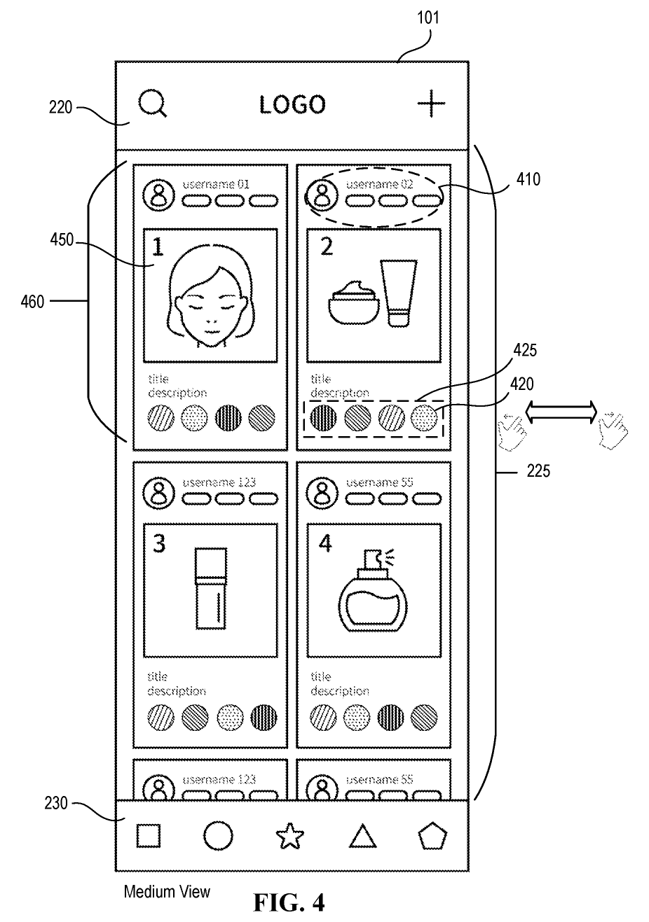

FIG. 4 illustrates an example of the medium view according to one embodiment. In the medium view, the content viewing area 225 includes multiple individual content windows 460 arranged in a matrix layout. Each individual content window 460 includes an image 450, which is a scaled-up version of the corresponding thumbnail 250 in the small view. The matrix layout in the medium view shows fewer and larger content windows 460 in the content viewing area 225 than the thumbnails 250 in the small view. In one embodiment, the matrix layout in the medium view is a dual-column layout. In some embodiments, a user may perform more than one un-pinch gesture to scale-up the thumbnails 250 in the small view to the dual-column layout.

As an example, each content window 460 in the medium view may display an online post, a.k.a. a social media post. In addition to the image 450, each content window 460 also includes one or more lists of clickable user interface (UI) elements 410 and one or more scrollable lists of UI elements next to and outside the image 450. The clickable UI elements 410 include icons, links, buttons, etc. Each clickable UI element 410 has a predetermined navigation flow for interacting with the user and providing information regarding the image content, the content creator, etc. The scrollable list of UI elements 420 includes icons and/or other graphical elements. A user may scroll the scrollable list of UI elements 420 in any of two opposite directions (e.g., left and right) to view additional icons/elements not displayed all at once in the content window 460. Each UI element 420 in the scrollable list has a predetermined navigation flow for interacting with the user. In the medium view, a user may select (e.g., click on) any of the UI elements 420 to view information about an attribute of the image content. For example, if the individual content window 460 displays a cosmetic product, each UI element 420 may be selected to show an available color and the related information of the cosmetic product having the selected color. As another example, if the content window 460 displays a person’s face wearing a makeup, each UI element 420 may be selected to show a cosmetic product that the person uses for the makeup. These UI elements 420 act as “quick browsing” facilitators by providing user-interactive features from an in-depth post, so that at a glance the key embedded information in the post can be displayed in a small area. This encourages fewer false clicks and/or more attention to the specific content that may spark further user interest. In some embodiments, the UI elements 420 are referred to as “quick browsing buttons”. This quick browsing means that the user does not have to click and load the main detailed post to see pertinent visual information for that post. Each UI element 420 corresponding to an image in a post can be clicked to display pertinent visual information about the image without the user clicking into the post. For example, the colors of a makeup shown in a post may be more important to a user than other aspects of the post, so by viewing the colors the user can know whether or not the post is interesting to them. When a user clicks on a UI element 420, the display 101 may show an extended content page in a new window or in the same individual content window 460. The new window may float on top of the content window 460. When the user finishes the quick browsing, the user may go back to the same content windows 460 in the same medium view by clicking on a back arrow, a close icon, and/or any viewable content in the background. It is understood that in an alternative embodiment, the scrollable list of UI elements 420 may be arranged differently from what is shown in FIG. 4. For example, the UI elements 420 may be arranged vertically and the user may scroll up and down in order to view all the icons. In some embodiments, each content window 460 may further include textual information indicating a title of the image 450, a description of the image 450, and other additional information.

It is noted that the area surrounding the scrollable list of UI elements 420, shown as a rectangular box in dash lines, is a trigger area 425. When the touch sensors in the trigger area 425 detect a scroll gesture in any of the left and right directions, additional UI elements 420 are scrolled into the content window 460 from one side while UI elements 420 on the opposite side are scrolled off the content window 460. That is, a user can initiate a scroll gesture anywhere within the trigger area 425 to view an extended list of UI elements 420. There is no need for the user to click onto a page to see the extended list of UI elements 420. During the scrolling of the UI elements 420, the touch sensors temporarily disable other gestures of clicking, tapping, pinching, un-pinching, and scrolling up and down the full page. Upon release of the scrolling action, the other gestures immediately are available. The scrolling of the UI elements 420 in the trigger area 425 functions in the same way in any of the viewing modes where the UI elements are displayed.

FIG. 5A illustrates an example of scrolling down in the medium view according to one embodiment, and FIG. 5B illustrates an example of scrolling up in the medium view according to one embodiment. The scrolling down/up in the medium view has the same effect on the displayed content as the scrolling down/up in the small view shown in FIGS. 3A and 3B. A user may scroll down or swipe down the content viewing area 225 and the header 220 disappears from the display 101. A user may scroll up or swipe up the content viewing area 225 and the footer 230 disappears from the display 101. When the user scrolls down (FIG. 5A) and then scrolls down (FIG. 5B), the previously-hidden header 220 is restored on the display 101. Conversely, when the user scrolls up (FIG. 5B) and then scrolls up (FIG. 5A), the previously-hidden footer 230 is restored on the display 101.

When the user performs an un-pinch gesture on the content viewing area 225 in the medium view, the viewing mode changes from the medium view to the standard view.

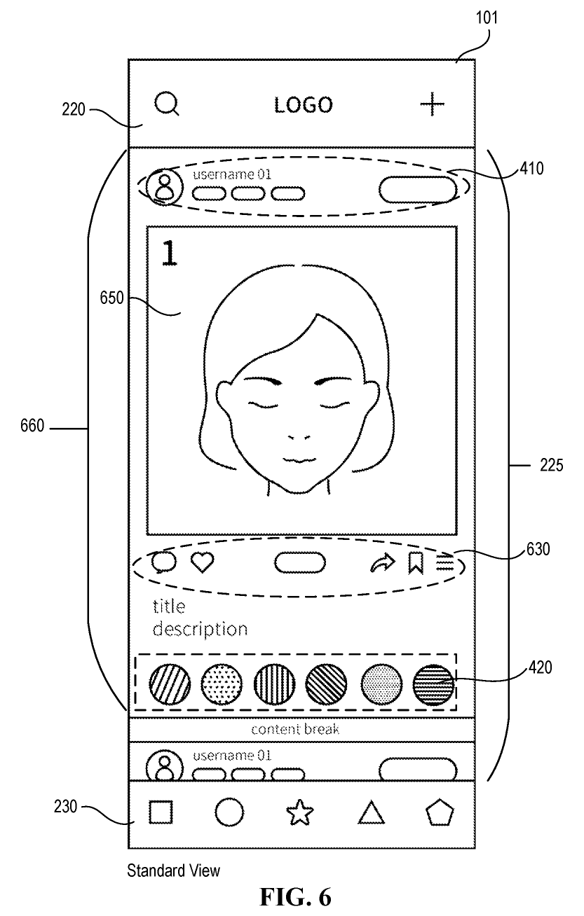

FIG. 6 illustrates an example of the standard view according to one embodiment. In the standard view, the content viewing area 225 shows individual content windows 660 stacked in one column or row. In the example of FIG. 6, the individual content windows 660 are arranged in a single-column layout and separated by a content break space. Each individual content window 660 further includes an image 650, which is a scaled-up version of the corresponding image 450 (FIG. 4) in the medium view. The individual content window 660 also includes the clickable UI elements 410 and the scrollable list of UI elements 420 next to and outside the image 650. The individual content window 660 may further include an interactive area 630 outside the image 650. The interactive area 630 includes multiple interactive UI elements that can be clicked on, toggled, or otherwise selected. Each interactive UI element has a predetermined navigation flow for interacting with the user. All of the elements 410, 420, and 630 are interactive and applicable to the image 650 such that the image 650 is an interactive image. These elements 410, 420, and/or 630 facilitate the interactivity of their corresponding image in any of the viewing modes where the elements are displayed.

FIG. 7A illustrates an example of scrolling down in the standard view according to one embodiment, and FIG. 7B illustrates an example of scrolling up in the standard view according to one embodiment. The scrolling down/up in the standard view has the same effect on the displayed content as the scrolling down/up in the medium view shown in FIGS. 5A and 5B. A user may scroll down or swipe down the content viewing area 225 and the header 220 disappears from the display 101. A user may scroll up or swipe up the content viewing area 225 and the footer 230 disappears from the display 101. When the user scrolls down (FIG. 7A) and then scrolls down (FIG. 7B), the previously-hidden header 220 is restored on the display 101. Conversely, when the user scrolls up (FIG. 7B) and then scrolls up (FIG. 7A), the previously-hidden footer 230 is restored on the display 101. The scrolling actions can cause the header 220 or footer 230 to disappear in any viewing mode, regardless of the navigation zoom-in state.

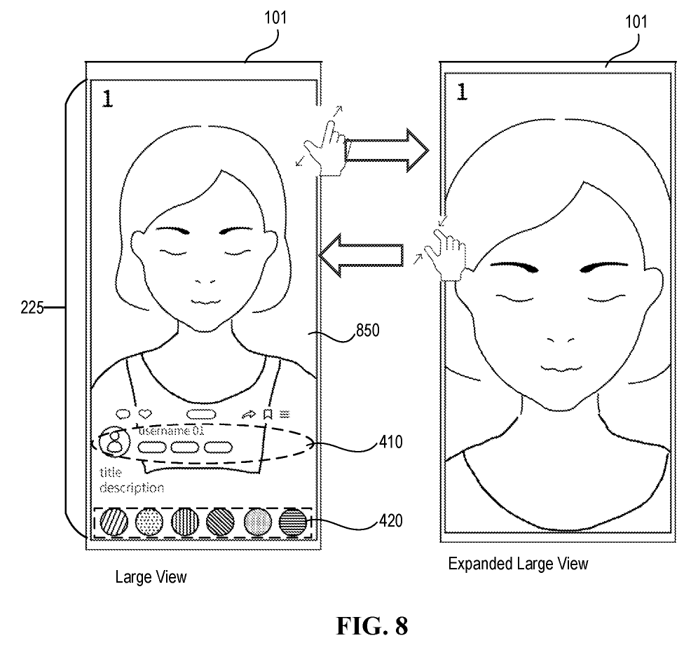

FIG. 8 illustrates an example of the large view and an expanded large view according to one embodiment. In the large view, both the header 220 and the footer 230 are removed from the display 101. The content viewing area 225 in the large view is the same as the individual content area and occupies the entire display 101 in both the horizontal and vertical directions. A single content window 850, which is a scaled-up version of the corresponding content window 650 (FIG. 6) in the standard view, expands to fill the content viewing area 225. The clickable UI elements 410 and the scrollable list of UI elements 420 are layered over the image in the content window 850 and may be placed anywhere within the content window 850.

In one embodiment, a user may perform an un-pinch gesture anywhere on the display 101 to further scale up the image in the content window 850. The un-pinch gesture changes the large view to an expanded large view, in which the clickable area 410, the scrollable list of UI elements 420, and any other interactive UI elements such as icons, links, selectable buttons are removed from the display 101 to maximize the image viewing for the user. The user may perform a pinch gesture to restore the expanded large view to the large view.

Referring to FIGS. 1-8, each image in any of the content windows 260 (FIG. 2), 460 (FIG. 4), and 660 (FIG. 6) is clickable; that is, a user may click on any of the images to get to the large view in FIG. 8. The user may also get to the large view by performing un-pinch gestures on any of the small view, the medium view, and the standard view. The user may want to stay in the small view to quickly browse through a large number of images. When the user identifies an image of interest, the user may obtain more information about the image by clicking on any UI elements in the medium view, standard view, and the large view to go to an extended content page. The extended content page has its own navigation flow. The content in the extended content page extends the content in the initial content window 660 with more details and further interactions than the initial content window 660. When the user determines to exit the extended content page to move on to other posts, the user can close that extended content page to return to the previous viewing mode and scroll through the other posts in that same viewing mode of the same content window size. If the user wants to see an enlarged version of the image, the user can perform one or more additional un-pinch gestures to get to the large view or expanded large view. The user may return to the medium view or the small view by performing a number of pinch gestures. Thus, the views of different scale factors are seamlessly integrated into a navigation flow that can be intuitively performed by a user’s pinch and un-pinch gestures.

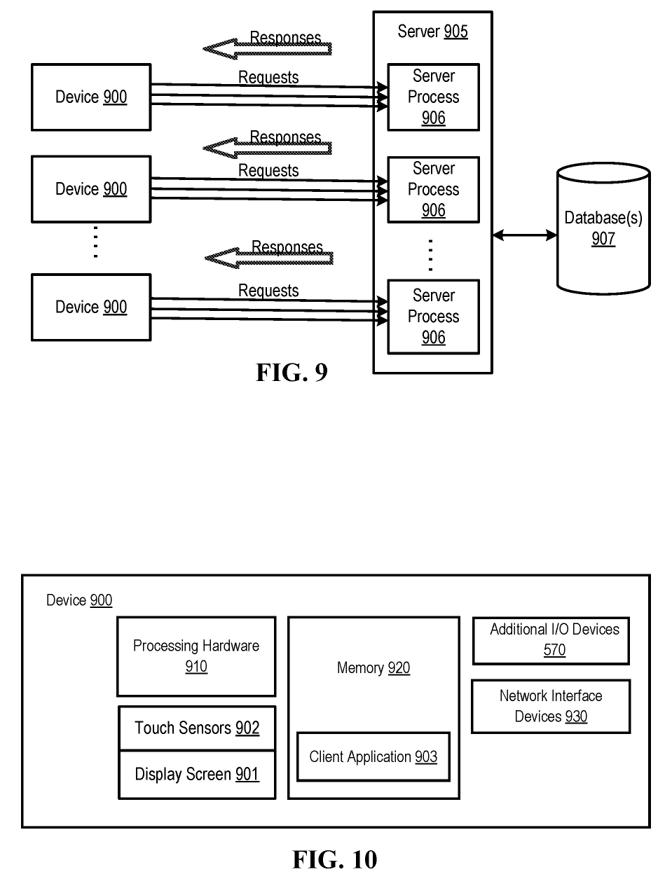

FIG. 9 is a block diagram illustrating multiple user devices 900 connected to a server 905 according to one embodiment. FIG. 10 is a block diagram illustrating the device 900 according to one embodiment. Referring to FIGS. 9 and 10, each device 900 includes a display screen 901, which may be a touch-sensing display having embedded touch sensors 902 to receive a user’s touch inputs, such as pinch, un-pinch, scroll, swipe, tap, click gestures, or other types of touch gestures. A client application 903 is stored in the memory of each device 900. The client application 903 may be an example of a social media application that causes the device 900 to display image-based posts in multiple viewing modes as illustrated in FIGS. 1-8. The client application 903 includes a gesture handler, which receives the user’s touch input and identifies the gesture type (e.g., pinch, un-pinch, click, scroll, etc.) and the corresponding content navigation. The gesture handler enables the displayed content to be touch-interactive even after changing the size of the content. The device 900 then requests the server 905 to respond to the requested content navigation. In one embodiment, the device 900 may also respond to identified gesture type, such as scrolling down/up in one of the viewing modes, by removing the header 220 or the footer 230 as described before.

The device 900 and the server 905 are communicatively connected via a network such as the Internet. The server 905 includes processors and memory. The server 905 can start multiple server processes 906, each server processes 906 responsible for handling the navigation requests from a corresponding device 900. The server processes 906 may execute the requests in parallel and asynchronously. The server 905 also has access to one or more databases 907, which store image-based posts, user profiles, and program code and data for providing a social media platform to participating users. The users may upload posts to the server 905, and may browse the posts of other users on their devices using the client application 903. In one embodiment, when the user performs a gesture that causes new content to be displayed (e.g., a pinch gesture, a scroll gesture, etc.), one or more navigation requests are sent to the server 905 and the server 905 responds with the new content for the display 900 to refresh its display screen 901.

In some embodiments, the device 900 may preload a portion of the contents from the server 905 and store in the memory such as dynamic random-access memory (DRAM) and/or static random-access memory (SRAM). In these embodiments, the device 900 may first check whether the user’s touch input can be responded by displaying the stored contents, and if it can the device 900 retrieves the stored contents for display without notifying the server 905. In one embodiment, the device 900 and the display screen 901 may be examples of the device 100 and the display 101 (FIG. 1), respectively.

In one embodiment, the device 900 includes processing hardware 910 such as one or more general-purpose processors including a central processing unit (CPU) and one or more special-purpose processing devices including a graphics processing unit (GPU). In one embodiment, the processing hardware 910 is operative to execute instructions of software applications including the client application 903 to provide a graphical user interface (GUI) for image-based content navigation described with reference to FIGS. 1-8.

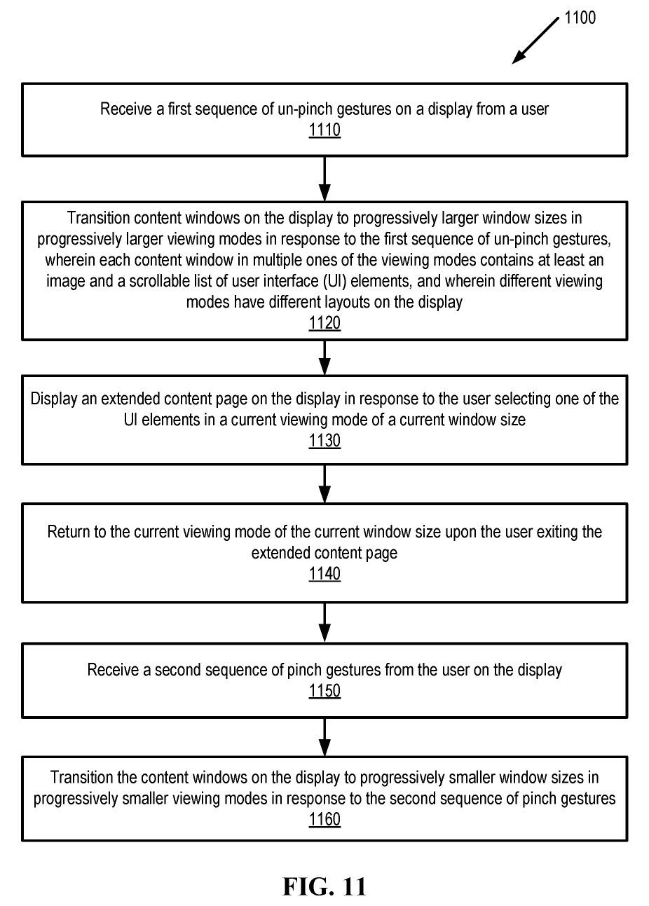

In one embodiment, the device 900 further includes memory 920 coupled to the processing hardware 910. The memory 920 may include memory devices such as DRAM, SRAM, flash memory, and other non-transitory machine-readable storage media; e.g., volatile or non-volatile memory devices. In one embodiment, the memory 920 may store instructions and data of the client application 903. The instructions, when executed by the processing hardware 910, cause the processing hardware 910 to perform the method 1100 of FIG. 11 and/or any of the content navigation operations described in connection with FIGS. 1-8.

The device 900 may further include network interface devices 930. A part or all of the data and code for the aforementioned client application 903 may be transmitted or received over a network via the network interface devices 930. The device 900 also includes the display screen 901 to provide a GUI to interact with users. The display screen 901 may be a touchscreen which may be overlaid with the touch sensors 902 to detect a user’s gesture inputs. The device 900 further includes additional input/output (I/O) devices 970; e.g., audio and video I/O devices, etc. It is understood the embodiment of FIG. 9 is simplified for illustration purposes. Additional hardware components may be included.

It is noted that the device 900 may be a computer, a portable computing and communication device (e.g., a smartphone, a laptop, a tablet, etc.), a wearable electronic device, a gaming device, an infotainment device, a navigation device, an Internet-of-things (IoT) device, or any machine capable of executing a set of instructions (sequential or otherwise) to provide the image-based content navigation described herein.

FIG. 11 is a flow diagram illustrating a method 1100 for image-based content navigation according to one embodiment. The method 1100 may be performed by the device 900 in FIGS. 9 and 10. The method 1100 begins at step 1110 when the device receives a first sequence of un-pinch gestures on a display from a user. At step 1120, the device transitions content windows on the display to progressively larger window sizes in progressively larger viewing modes in response to the first sequence of un-pinch gestures. Each content window in multiple ones of the viewing modes contains at least an image and a scrollable list of UI elements, and different viewing modes have different layouts on the display. At step 1130, the device displays an extended content page on the display in response to the user selecting one of the UI elements in a current viewing mode of a current window size. At step 1140, the device returns to the current viewing mode of the current window size upon the user exiting the extended content page. At step 1150, the device receives a second sequence of pinch gestures from the user on the display. At step 1160, the device transitions the content windows on the display to progressively smaller window sizes in progressively smaller viewing modes in response to the second sequence of pinch gestures.

In one embodiment, the scrollable list of UI elements is scrollable in two opposite directions to display additional UI elements when a scroll gesture is detected within a trigger area of the display, and each UI element in the scrollable list is selectable by the user to display a corresponding attribute of a corresponding image.

In one embodiment, the viewing modes may include a small view, in which the content windows are arranged in a multi-column matrix layout and each content window includes a thumbnail image. The viewing modes may include a medium view, in which the content windows are arranged in a dual-column matrix layout and each content window includes a corresponding image and a corresponding scrollable list of UI elements. The viewing modes may include a standard view, in which the content windows are arranged in a single-column layout, and wherein each content window displays the scrollable list of UI elements outside the image in the content window. The viewing modes may include a large view, in which a single content window is displayed, and wherein the scrollable list of UI elements is layered over the image in the single content window. In one embodiment, each content window in each of the viewing modes contains a social media post, and each UI element corresponding to a given image in the content window is clickable to display pertinent visual information about the given image without the user clicking into the social media post.

In one embodiment, the device may receive an un-pinch gesture in the large view. In response to the un-pinch gesture, the device scales up a portion of the image and removes the scrollable list of UI elements from the display. In one embodiment, the image in each of the viewing modes, when clicked by the user, causes the large view to be displayed.

In one embodiment, the device receives a scroll gesture on the display toward a first end of the display. In response to the scroll gesture, an end section is moved from the display, wherein the end section is at a second end of the display opposite to the first end. In one embodiment, each of the viewing modes is scrollable to display new contents. In one embodiment the device may switch back and forth between two different ones of the viewing modes when receiving alternating un-pinch and pinch gestures.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method of image-based content navigation, comprising:
receiving a first sequence of un-pinch gestures on a display from a user;
transitioning content windows on the display to progressively larger window sizes in progressively larger viewing modes in response to the first sequence of un-pinch gestures, wherein each content window in multiple ones of the viewing modes contains at least an image and a scrollable list of user interface (UI) elements, and wherein different viewing modes have different layouts on the display;
displaying an extended content page on the display in response to the user selecting one of the UI elements in a current viewing mode of a current window size;
returning to the current viewing mode of the current window size upon the user exiting the extended content page;
receiving a second sequence of pinch gestures on the display; and
transitioning the content windows on the display to progressively smaller window sizes in progressively smaller viewing modes in response to the second sequence of pinch gestures.

2. The method of claim 1, wherein the scrollable list of UI elements is scrollable in two opposite directions to display additional UI elements when a scroll gesture is detected within a trigger area of the display, and each UI element in the scrollable list is selectable by the user to display a corresponding attribute of a corresponding image.

3. The method of claim 1, wherein the viewing modes includes a small view, in which the content windows are arranged in a multi-column matrix layout and each content window includes a thumbnail image.

4. The method of claim 1, wherein the viewing modes includes a medium view, in which the content windows are arranged in a dual-column matrix layout and each content window includes a corresponding image and a corresponding scrollable list of UI elements.

5. The method of claim 1, wherein the viewing modes includes a standard view, in which the content windows are arranged in a single-column layout, and wherein each content window displays the scrollable list of UI elements outside the image in the content window.

6. The method of claim 1, wherein the viewing modes includes a large view, in which a single content window is displayed, and wherein the scrollable list of UI elements is layered over the image in the single content window.

7. The method of claim 6, further comprising:
receiving an un-pinch gesture in the large view; and
in response to the un-pinch gesture, scaling up a portion of the image and removing the scrollable list of UI elements from the display.

8. The method of claim 6, wherein the image in each of the viewing modes, when clicked by the user, causes the large view to be displayed.

9. The method of claim 1, further comprising:
receiving a scroll gesture on the display toward a first end of the display; and
removing an end section from the display in response to the scroll gesture, wherein the end section is at a second end of the display opposite to the first end.

10. The method of claim 1, each of the viewing modes is scrollable to display new contents.

11. The method of claim 1, further comprising:
switching back and forth between two different ones of the viewing modes when receiving alternating un-pinch and pinch gestures.

12. The method of claim 1, wherein each content window in each of the viewing modes contains a social media post, and wherein each UI element corresponding to a given image in the content window is clickable to display pertinent visual information about the given image without the user clicking into the social media post.

13. A device operative to provide image-based content navigation, comprising:
processing hardware; and
memory to store a client application with which a user interacts using gestures;
wherein the one or more processors are operative to:
receive a first sequence of un-pinch gestures from the user on a display;
transition content windows on the display to progressively larger window sizes in progressively larger viewing modes in response to the first sequence of un-pinch gestures, wherein each content window in multiple ones of the viewing modes contains at least an image and a scrollable list of user interface (UI) elements, and wherein different viewing modes have different layouts on the display;
display an extended content page on the display in response to the user selecting one of the UI elements in a current viewing mode of a current window size;
return to the current viewing mode of the current window size upon the user exiting the extended content page;
receive a second sequence of pinch gestures on the display; and
transition the content windows on the display to progressively smaller window sizes in progressively smaller viewing modes in response to the second sequence of pinch gestures.

14. The device of claim 13, wherein the scrollable list of UI elements is scrollable in two opposite directions to display additional UI elements when a scroll gesture is detected within a trigger area of the display, and each UI element in the scrollable list is selectable by the user to display a corresponding attribute of a corresponding image.

15. The device of claim 13, wherein the viewing modes includes a small view, in which the content windows are arranged in a multi-column matrix layout and each content window includes a thumbnail image.

16. The device of claim 13, wherein the viewing modes includes a medium view, in which the content windows are arranged in a dual-column matrix layout and each content window includes a corresponding image and a corresponding scrollable list of UI elements.

17. The device of claim 13, wherein the viewing modes includes a standard view, in which the content windows are arranged in a single-column layout, and wherein each content window displays the scrollable list of UI elements outside the image in the content window.

18. The device of claim 13, wherein the viewing modes includes a large view, in which a single content window is displayed, and wherein the scrollable list of UI elements is layered over the image in the single content window.

19. The device of claim 13, wherein the one or more processors are further operative to:
receive a scroll gesture on the display toward a first end of the display; and
remove an end section from the display in response to the scroll gesture, wherein the end section is at a second end of the display opposite to the first end.

20. The device of claim 13, wherein each content window in each of the viewing modes contains a social media post, and wherein each UI element corresponding to a given image in the content window is clickable to display pertinent visual information about the given image without the user clicking into the social media post.
